(19) United States
(12) Patent Application Publication
(10) Pub. No.: US 2007/0185765 A1
(43) Pub. Date: Aug. 9, 2007

(54) Method for registering a collectible

(76) Inventor: Joseph Dennis Radcliffe, Elkapark, NY (US)

Correspondence Address: GLOBAL PATENTS, Suite 120, 838 West Long Lake Rd, Bloomfield Hills, MI, 48302, US

(21) Appl. No.: 11/347,763

(22) Filed: Feb. 6, 2006

(51) Int. Cl. G07G 1/14

(52) U.S. Cl. 705/14

(57) ABSTRACT

A method for registering a collectible, and a subsequent method for verifying the registration, can be carried out by first collecting a registration fee, then receiving purchaser and collectible information, then inputting the information into a database, then assigning a certificate number and registration number for the collectible, and then sending a Certificate of Registration to the purchaser.

### FIELD OF THE INVENTION

The present invention generally relates to a registration method, and more particularly, relates to a method for a purchaser of a collectible to register ownership of the collectible with a registration company.

### BACKGROUND OF THE INVENTION

Valuable collectibles are frequently sold, exchanged or otherwise transferred ownership at business establishments such as jewelry stores, art galleries, auction houses, or other places of business. These valuable collectibles, include, but not limited to, a piece of fine art, sports or other memorabilia, fine jewelry, valuable artifacts, signed collectibles and collectible art, etc. Some retail establishment offers registration through their own numbering system of each piece sold and provides a document such as a “Certificate of Authenticity”. However, such store registration systems and such Certificate of Authenticity are not offered on a nation-wide, or world-wide basis, and are generally limited to a localized area or region. A person would not be able to trace a chain of ownership of a collectible through a nation-wide or world-wide registration system.

It is desirable that a nation-wide or world-wide registration system to be provided such that a purchaser of a collectible can register his or her purchase with peace of mind, knowing that a clear chain of title can be proven in the registration system.

It is therefore an object of the present invention to provide a method for registering a collectible that does not have the drawbacks or shortcomings of the conventional store registration method.

It is another object of the present invention to provide a method for registering a collectible after a purchaser made the purchase that can be used to substantiate ownership and a chain of ownership of the collectible.

It is another object of the present invention to provide a method for registering a collectible through a registration company whereby a registration of a collectible can be verified by the purchaser or by any other authorized person.

### SUMMARY OF THE INVENTION

In accordance with the present invention, a method for registering a collectible such that the ownership, or the chain of ownership, can be verified by the purchaser or by any other authorized person is provided.

In a preferred embodiment, the method for registering a collectible by a registration company can be carried out by the steps of collecting a registration fee from the purchaser of a collectible; then receiving purchaser and collectible information on the collectible; then inputting the purchaser and collectible information into a database; then assigning a certificate number and a registration number for the collectible; and then sending a certificate of registration to the purchaser.

### BRIEF DESCRIPTION OF THE DRAWINGS

The invention will now be described, by way of example, with reference to the accompanying drawings, in which:

FIG. 1 is a block diagram illustrating the present invention registration process.

FIG. 2 is a block diagram illustrating a verification process for the present invention registration method.

FIG. 3 illustrate a sample of the Certificate of Registration.

FIG. 4 illustrate a customer information page for the verification process.

FIG. 5 illustrate a user information page for the present invention verification process.

FIG. 6 illustrate a list of certificates page for the present registration method.

### DETAILED DESCRIPTION OF THE PREFERRED EMBODIMENT

The present invention discloses a method for registering a collectible by a registration company such that the registration can be verified by the purchaser of the collectible, or by any other authorized person in a future date. The present invention method for registering a collectible not only allows a person to verify his or her ownership, but also allows the person to verify the chain of ownership, if the collectible has been sold, exchanged, or otherwise ownership changed hands.

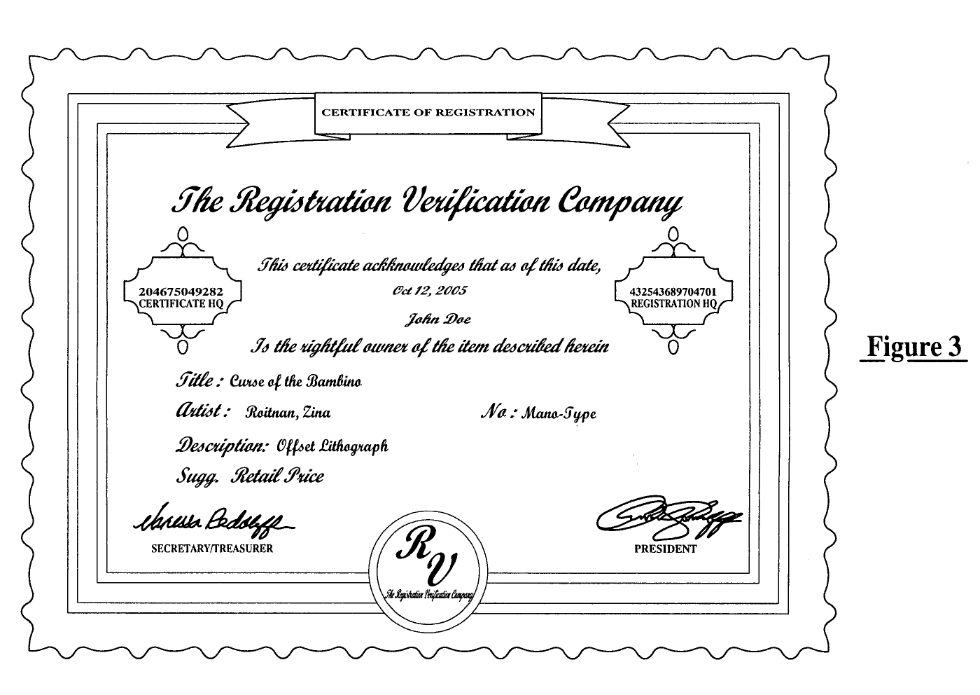

The present invention registration method can be carried out by the following steps. First, the purchaser or collector of the collectible pays a fee for the service at the time of purchase of the collectible, to the vendor. The vendor retrieves information from the purchaser or collector as to the date and place of purchase, the purchaser's name, address, and contact information, the collectible purchased, and any other necessary information. In the next step, the vendor submits the information package, usually in a written form, to the registration company. The registration company administrator logs onto the administrative portion of a website using a special website address and special administrative log-on codes. The administrator then manually inputs all the data into the database through the Internet entering area of the website, or the administrator site. After the information is inputted, the site program automatically, or upon prompt, initiates for the particular purchaser or collector and the particular purchase a certificate number, and a registration number. An actual “Certificate of Registration” such as that shown in FIG. 3, which contains the certificate date, purchaser's name, title of the collectible, artist's name, the piece number, a description of the item, a suggested retail price, the certificate number, the registration number, the official company seal, and signature of the company treasurer and president is generated. In the last step of the process, the certificate is mailed to the purchaser or collector from the registration company.

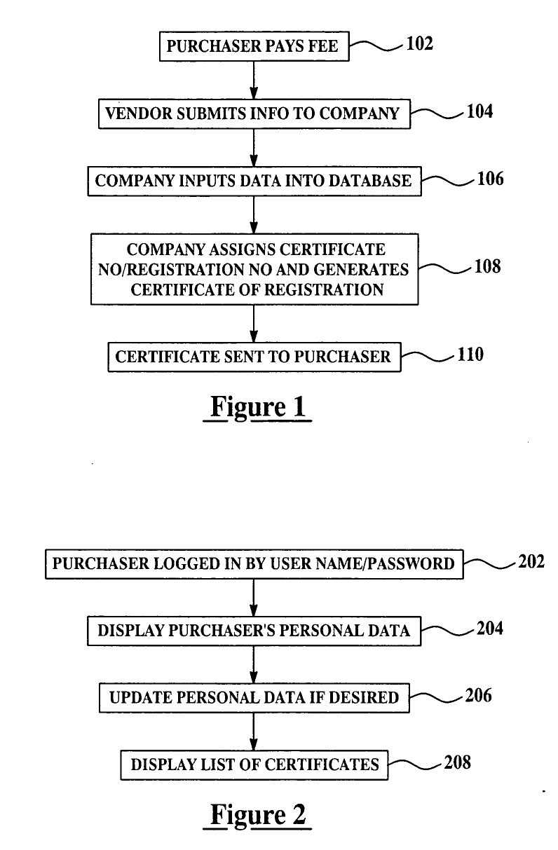

These registration steps are shown in FIG. 1. For instance, step 102 shows that the purchaser pays a fee, step 104 shows the vendor submits information to the registration company, step 106 shows the registration company inputs data into the database, step 108 shows the registration company assigns certificate number and registration number and generates a nation-wide “Certificate of Registration”, and then step 110 shows the registration company sends the certificate to the purchaser or collector.

Once the registration process is completed, and the purchaser or collector has received the certificate, he or she can visit the website www.registrationverification.com and log in using the certificate number and registration number to verify his or her registration. The verification process is shown in FIG. 2. In the first step 202 of the Verification Process, the purchaser first logged in by user name and password. The computer screen first shows the “Home” site and the registration benefits provided by the registration company. For instance, the registration benefits include: First, the purchaser receives a Certificate of Registration in his or her name, including a detailed description of the collectible. Secondly, the registration maintains/increases the value of the collectible. Thirdly, the registration establishes a chain of custody. Fourthly, the registration allows prospective purchasers to verify the collectible's chain of ownership.

The computer screen further shows the benefits of the verification process. First, the verification process increases the enjoyment of the collectible by viewing a photo or video of the actual signing of the collectible. Secondly, the registration establishes the ownership of the collectible. It offers the security of storing the ownership title and the chain of custody. The verification process allows a purchaser to view the occasion when the work was signed.

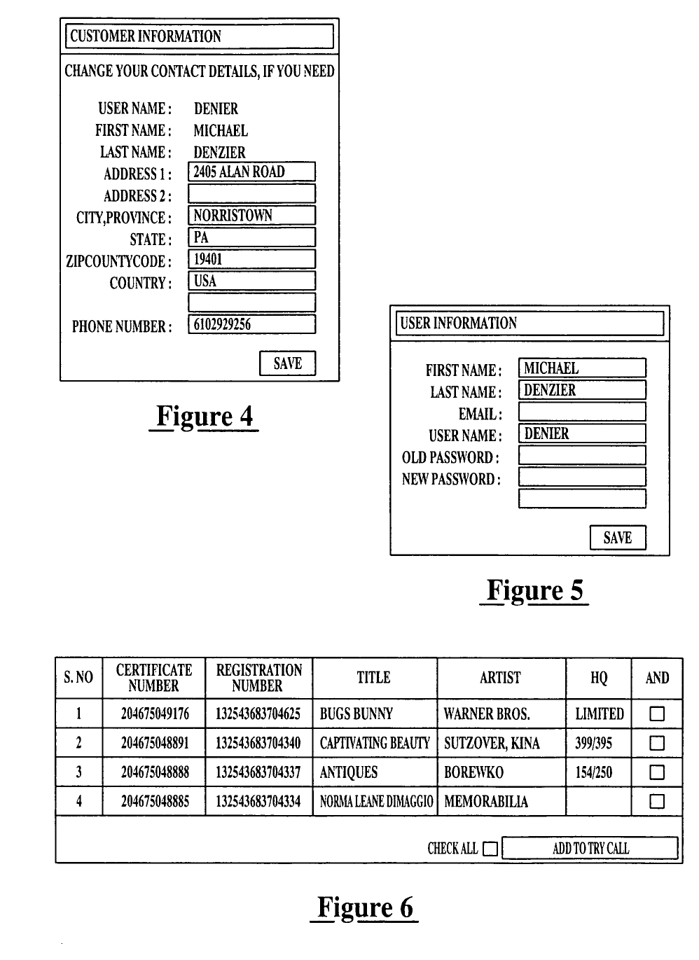

In the second step 204 of the verification process, the computer screen displays the purchaser's personal data, a sample screen of such is shown in FIG. 4. The personal data displayed includes the certificate number, the registration number, the title, the artist, the number, and a question as to whether the purchaser would like to add to the collection information. The purchaser has a choice at the screen of choosing “My Certificate”, which actually shows the certificate on the screen. The computer screen further shows contact details, which allow the purchaser to update and make changes to data such like the address, the password, etc. This is the third step, 206, shown on FIG. 2. A sample screen of step 206 is further shown in FIG. 5.

In the final step 208 of the verification process, a list of the certificates is displayed on the computer screen such that the purchaser can review a particular certificate in the list by selecting for viewing on line. The purchaser may also have choices of selections such as “all certificates”, “add certificates”, “view certificate”, “exit”, etc. A sample screen for step 208 is shown in FIG. 6.

The present invention registration method, and the subsequent verification method, allows a collectible purchaser to buy with confidence when a collectible is registered. The registration process establishes the ownership of a new collectible, or continues the unbroken chain of ownership of a previously sold or traded collectible.

The present invention registration method further provides the additional benefits of credibility for registering the collectible when a possible insurance claim for theft, flood, or other hazards is made of the collectible.

The present invention registration method for registering a collectible, and the subsequent method for verification, have therefore been amply described in the above descriptions, and in the appended drawings of FIGS. 1-6.

While the preferred embodiments of the invention have been described above, it will be recognized and understood that various modifications can be made in the invention and the appended claims are intended to cover all such modifications which may fall within the spirit and scope of the invention.

What is claimed:

1. A method of registering a collectible by a registration company comprising the steps of:
collecting a registration fee from a purchaser of a collectible;
receiving purchaser and collectible information on said collectible;
inputting said purchaser and collectible information into a database;
assigning certificate number and registration number for said collectible; and
sending a certificate of registration to said purchaser.

2. The method for registering a collectible by a registration company according to claim 1, wherein said registration fee collection step is performed by a vendor for the collectible.

3. The method for registering a collectible by a registration company according to claim 1, wherein said step of receiving purchaser and collectible information is performed by a vendor for the collectible.

4. The method for registering a collectible by a registration company according to claim 1, wherein said step of inputting the purchaser and collectible information into a database is carried out by the registration company.

5. The method for registering a collectible by a registration company according to claim 1, wherein said step of assigning certificate number and registration number for the collectible is carried out by the registration company.

6. The method for registering a collectible by a registration company according to claim 1, wherein said step of sending a certificate of registration to the purchaser is carried out by the registration company.

7. The method for registering a collectible by a registration company according to claim 1 further comprising the step of verifying the registration by the purchaser subsequent to said sending a certificate of registration step.

8. The method for registering a collectible by a registration company according to claim 7 further comprising the step of entering and updating the database of the personal information of the purchaser.

9. The method for registering a collectible by a registration company according to claim 7 further comprising the step of displaying a list of more than one certificate.
